(19) United States
(12) Patent Application Publication
(10) Pub. No.: US 2024/0289201 A1
(43) Pub. Date: Aug. 29, 2024

(54) SYSTEM, METHOD, AND NON-TRANSITORY COMPUTER-READABLE MEDIA FOR PROVIDING CLOUD APPLICATION FAULT DETECTION

(71) Applicant: Rakuten Mobile, Inc., Tokyo (JP)

(72) Inventors: Vivek NAGAR, Indore (IN); Chitra MOHANANI, Indore (IN); Taresh SONI, Indore (IN); Mohak SONI, Indore (IN); Ashish TALANKAR, Indore (IN); Jayesh VERMA, Indore (IN)

(21) Appl. No.: 18/044,781

(22) PCT Filed: Aug. 10, 2022
(86) PCT No.: PCT/US2022/039896

§ 371 Date: Mar. 10, 2023

(51) Int. Cl. G06F 11/07; G06F 11/32

(52) U.S. Cl. CPC G06F 11/0787; G06F 11/0712; G06F 11/327

(57) ABSTRACT

Cloud application fault detection is described. At an observability framework implemented by a processor, log files associated with applications are received, wherein the log files are automatically streamed from at least one log directory. A template is applied to the log files automatically streamed from the at least one log directory as the log files are received to identify faults of the applications associated with the log files. The log files automatically streamed from the at least one log directory are processed as the log files are received based on the faults to generate an error message identifying the faults of the applications associated with the log files.

### TECHNICAL FIELD

This description relates to a system, method, and non-transitory computer-readable media for providing cloud application fault detection

### BACKGROUND

The scale and complexity of application deployment continues to increase. Understanding how these applications perform, when failure occurs, and what actions need to be taken to address performance is becoming increasingly difficult. To address these issues, characterizing and detecting problems with applications with post-detection diagnostics has become a common task.

Logs play a key role in identifying the root cause of application faults. Applications write log files to a log directory in response to a fault occurring. The log files from the log directories are capable of providing identification of the faults. Thus, workers, such as application developers and members of the development operations team, access the environment, such as Apache servers, to identify and troubleshoot faults from log files stored at log directories.

To read the logs from the log directory, workers access the log directories manually, and then refine the manually accessed log records to determine error messages. After the error messages are determined, actions are identified to address the error messages. Quick and easy identification of faults from logs is not currently possible. While manually reading logs can work for smaller applications, large applications can generate thousands of events per second, making manual analysis impossible. Manually reading logs becomes worse when applications are deployed on multiple servers, which may be geographically distributed.

### SUMMARY

In at least embodiment, a method for providing cloud application fault detection includes receiving, at a processor from at least one log directory associated with at least one server, log files associated with applications running on the at least one server, the log files automatically streamed from the at least one directory, storing in memory by the processor, the log files automatically streamed from the at least one log directory as the log files are received, obtaining, by the processor from a database, a template for identifying faults of the applications associated with the log files automatically streamed from the at least one log directory, applying, by the processor, the template to the log files stored in the memory to identify the faults of the applications associated with the log files, obtaining, by the processor from the database, a configuration file from the database for generating an error message identifying the faults of the applications associated with the log files automatically streamed from the at least one log directory, applying, by the processor, the configuration file to the log files stored in the memory to generate the error message identifying the faults of the applications associated with the log files, and transmitting, by the processor over a network, the error messages to an operations support system for addressing the faults of the applications associated with the log files.

In at least embodiment, a system for providing cloud application fault detection includes a memory storing computer-readable instructions, and a processor connected to the memory, wherein the processor is configured to execute the computer-readable instructions to receive, from at least one log directory associated with at least one server, log files associated with applications running on the at least one server, the log files automatically streamed from the at least one directory, store in the memory the log files automatically streamed from the at least one log directory as the log files are received, obtain, from a database, a template for identifying faults of the applications associated with the log files automatically streamed from the at least one log directory, apply the template to the log files stored in the memory to identify the faults of the applications associated with the log files, obtain, from the database, a configuration file from the database for generating an error message identifying the faults of the applications associated with the log files automatically streamed from the at least one log directory, apply the configuration file to the log files stored in the memory to generate the error message identifying the faults of the applications associated with the log files, and transmit, over a network, the error messages to an operations support system for addressing the faults of the applications associated with the log files.

In at least embodiment, a non-transitory computer-readable media having computer-readable instructions stored thereon, which when executed by a processor causes the processor to perform operations including receiving, at an observability framework implemented by the processor, log files associated with applications, the log files automatically streamed from at least one log directory, applying a template to the log files automatically streamed from the at least one log directory as the log files are received to identify faults of the applications associated with the log files, and processing the log files automatically streamed from the at least one log directory as the log files are received based on the faults to generate an error message identifying the faults of the applications associated with the log files.

### BRIEF DESCRIPTION OF THE DRAWINGS

Aspects of the present disclosure are best understood from the following detailed description when read with the accompanying figures. It is noted that, in accordance with the practice in the industry, various features are not drawn to scale. In fact, the dimensions of the various features are able to be increased or reduced for clarity of discussion.

FIG. 1 illustrates an Observability Framework (OBF) according to at least one embodiment.

FIG. 2 illustrates a Log Shipper according to at least one embodiment.

FIG. 3 illustrates a Log Processing System according to at least one embodiment.

FIG. 4 is a flowchart of a method for providing cloud application fault detection according to at least one embodiment.

FIG. 5 is a high-level functional block diagram of a processor-based system according to at least one embodiment.

### DETAILED DESCRIPTION

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are used herein for ease of description to describe one element or feature's relationship to another element(s) or feature(s) as illustrated in the figures. The spatially relative terms are intended to encompass different orientations of the device in use or operation in addition to the orientation depicted in the FIGS. The apparatus is otherwise oriented (rotated 90 degrees or at other orientations) and the spatially relative descriptors used herein likewise are interpreted accordingly.

Embodiments described herein describes examples for implementing different features of the provided subject matter. Examples of components, values, operations, materials, arrangements, or the like, are described below to simplify the present disclosure. These are, of course, examples and are not intended to be limiting. Other components, values, operations, materials, arrangements, or the like, are contemplated. For example, the formation of a first feature over or on a second feature in the description that follows include embodiments in which the first and second features are formed in direct contact and include embodiments in which additional features are formed between the first and second features, such that the first and second features are unable to make direct contact. In addition, the present disclosure repeats reference numerals and/or letters in the various examples. This repetition is for the purpose of simplicity and clarity and does not in dictate a relationship between the various embodiments and/or configurations discussed.

Embodiments described herein provide a system, method, and non-transitory computer-readable media for providing cloud application fault detection. At an observability framework implemented by a processor, log files associated with applications are received, wherein the log files are automatically streamed from at least one log directory. A template is applied to the log files automatically streamed from the at least one log directory as the log files are received to identify faults of the applications associated with the log files. The log files automatically streamed from the at least one log directory are processed as the log files are received based on the faults to generate an error message identifying the faults of the applications associated with the log files.

Advantages include a system that provides quick and easy identification of faults from logs as log files are received. The cloud application fault detection enables events from large applications to be processes. Further, the cloud application fault detection is able to handle log files received from multiple, geographically distributed servers. The cloud application fault detection provides automated collection of log files for analysis in the cloud, rather than relying on personnel to manually access logs files directly from log directories

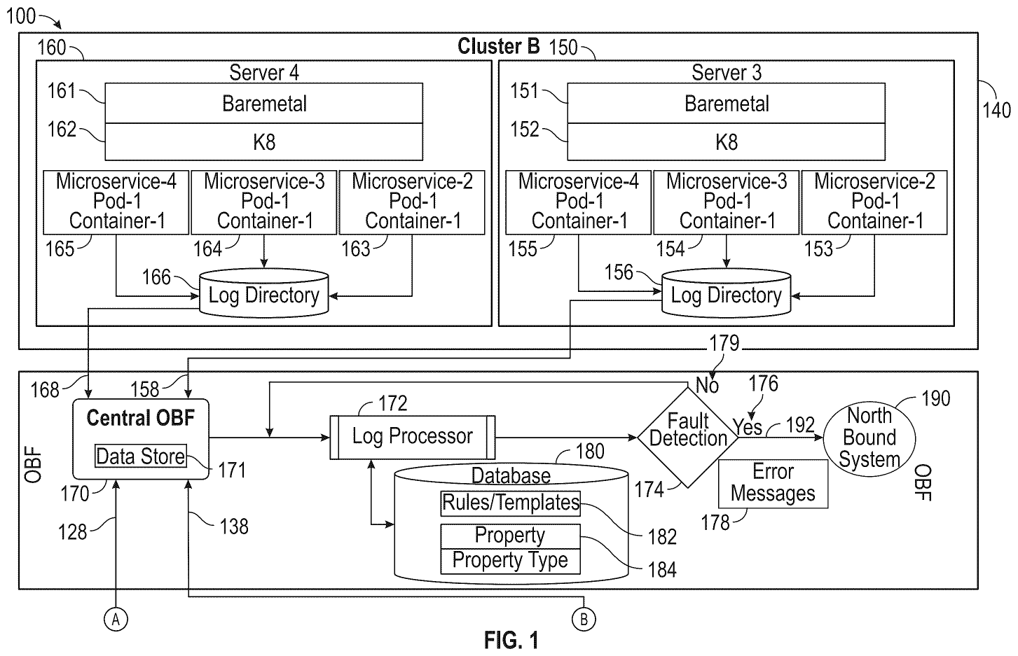

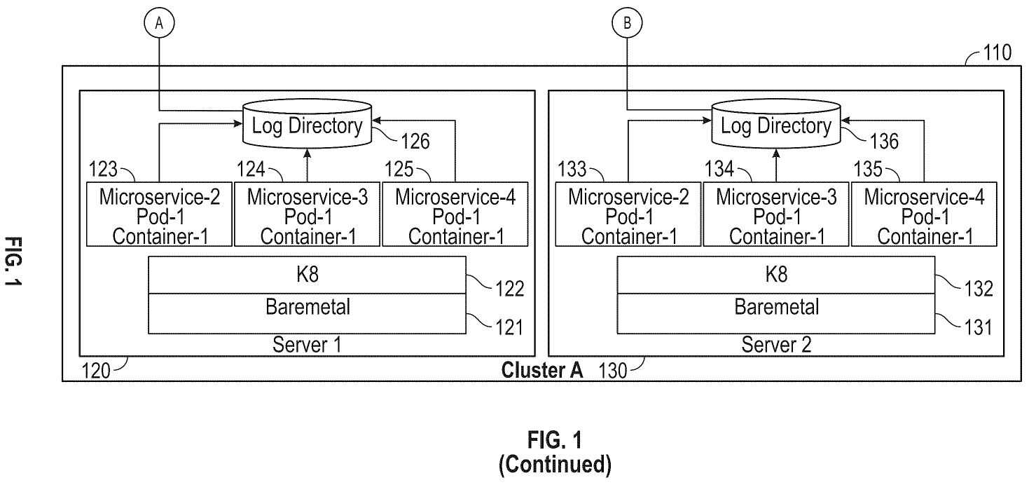

FIG. 1 illustrates an Observability Framework (OBF) 100 according to at least one embodiment.

In FIG. 1, Cluster A 110 includes Server 1 120 and Server 2 130. Server 1 is implemented using Baremetal operating system 121. Baremetal operating system 121 provides a physical computer specifically designed to run dedicated services without any interruptions for extended periods. The term ‘baremetal’ is used to refer to a physically dedicated server rather than a virtualized environment and modern cloud hosting forms. Within a data center, servers based on Baremetal operating system 121 are not shared between multiple clients. When using Baremetal operating system 121, other users do not compete on the same system for resources so that users are provided higher performance. A dedicated server based on Baremetal operating system 121 is able to handle a more significant workload than a similar virtual machine in most cases. This allows dedicated hosting to be provided to users that need top levels of performance. Compared to other types of dedicated servers, servers based on Baremetal operating system 121 is often easier to manage.

Kubernetes (K8) 122 is shown running on Baremetal operating system 121. K8 122 provides an open-source container management platform for managing containerized applications in a clustered environment. K8 122 is configured to instruct a data shipper how to treat logs stored in a log directory. For example, in at least one embodiment, Kubernetes uses pod annotations to tell a data shipper how to treat logs stored in a log directory. Data shippers are configured on a server to send data to a predetermined location. In K8 122 a pod represents a group of one or more containers running together, wherein a pod is the smallest execution unit in Kubernetes 122. A pod encapsulates one or more applications and includes one or more containers. Containers separate functions within a server and run logically in a pod. A container includes storage/network resources, and a specification for how to run the containers.

Applications represented by Microservices are running in a cloud environment and are writing logs to a log directory. Server 1 120 provides Microservice-2 123, Microservice-3 124, and Microservice-4 125. Microservice-2 123, Microservice-3 124, and Microservice-4 125 are applications and are carried in Container 1 and deployed in Pod-1. Microservice-2 123, Microservice-3 124, and Microservice-4 125 write log files to Log Directory 126 in Server 1 120. Log files are explanatory records of events regarding the application, its performance, and user activities. Examples of events include deleting, or modifying a file for the application. They also include system configuration changes. Thus, log files are useful in identifying and correcting problems.

Cluster A 110 also includes Server 2 130 that is implemented using Baremetal operating system 131. Kubernetes (K8) 132 is running on Baremetal 131. Server 1 130 provides Microservice-2 133, Microservice-3 134, and Microservice-4 135. Microservice-2 133, Microservice-3 134, and Microservice-4 135 are applications and are carried in Container 1 and deployed in Pod-1. Microservice-2 133, Microservice-3 134, and Microservice-4 135 write log files to Log Directory 136 in Server 1 130.

Cluster B 140 includes Server 3 150 and Server 4 160. Server 4 150 is implemented using Baremetal operating system 151. Kubernetes (K8) 152 is running on Baremetal 151. Server 1 150 provides Microservice-2 153, Microservice-3 154, and Microservice-4 155. Microservice-2 153, Microservice-3 154, and Microservice-4 155 are applications and are carried in Container 1 and deployed in Pod-1. Microservice-2 153, Microservice-3 154, and Microservice-4 155 write log files to Log Directory 156 in Server 1 150.

Cluster B 140 also includes Server 4 160. Server 4 160 is implemented using Baremetal operating system 161. Kubernetes (K8) 162 is running on Baremetal 161. Server 1 160 provides Microservice-2 163, Microservice-3 164, and Microservice-4 165. Microservice-2 163, Microservice-3 164, and Microservice-4 165 are applications and are carried in Container 1 and deployed in Pod-1. Microservice-2 163, Microservice-3 164, and Microservice-4 165 write log files to Log Directory 166 in Server 1 160.

Microservices 123-125, 133-135, 153-155, 163-155 have applications running on the K8 layers 122, 132, 152, 162, respectively. K8 layers 122, 132, 152, 162 manage the applications containers. Applications of Microservices 123-125, 133-135, 153-155, 163-155 write log files to Log Directories 126, 136, 156, 166. For example, applications of Microservices 123-125, 133-135, 153-155, 163-155 generate log files on a regular basis, e.g., how many users have logged into an application, how many users are trying to access a particular feature of the application, etc. The applications are capable of generating thousands of log files. In response to an issue associated with a fault condition occurring in applications of Microservices 123-125, 133-135, 153-155, 163-155, identification of the issue is written in a log file that is stored in Log Directories 126, 136, 156, 166.

Observability Framework (OBF) 100 provides automated collection of log files for analysis in the cloud, rather than relying on personnel to manually access logs files directly from Log Directories 126, 136, 156, 166. OBF 100 includes a Central OBF device 170. OBF 100 is coupled via Connection 128 to Log Directory 126 of Server 1 120. OBF 100 is coupled via Connections 138 to Log Directory 136 of Server 2 130. OBF 100 is coupled via Connection 158 to Log Directory 156 of Server 3 150. OBF 100 is coupled via Connection 168 to Log Directory 166 of Server 4 160.

Connections 128, 138, 158, 168 are implemented using at least one of a wireless connection and a wired connection. In at least one embodiment, Connections 128, 138, 158, 168 are implemented as a wireless connection in accordance with any IEEE 802.11 Wi-Fi protocols, Bluetooth protocols, Bluetooth Low Energy (BLE), or other short range protocols that operate in accordance with a wireless technology standard for exchanging data using any licensed or unlicensed band such as the citizens broadband radio service (CBRS) band, 2.4 GHz bands, 5 GHz bands, or 6 GHz bands. Additionally, in at least one embodiment, Connections 128, 138, 158, 168 are implemented using a wireless connection that operates in accordance with, but is not limited to, RF4CE protocol, ZigBee protocol, Z-Wave protocol, or IEEE 802.15.4 protocol. In at least one embodiment, Connections 128, 138, 158, 168 are implemented using a coax (MoCA) network. In at least one embodiment, Connections 128, 138, 158, 168 are a wired Ethernet connection.

Central OBF device 170 receives log files from Log Directories 126, 136, 156, 166. For example, Log Directories 126, 136, 156, 166 stream log files to Central OBF 170. By steaming the log files from Log Directories 126, 136, 156, 166, a persistent or continuous flow is provided to Central OBF 170 for processing by Log Processor 172. Central OBF 170 provides automated collection of log files for analysis thereby providing improved operations.

Central OBF 170 implements Data Store 171 for continuously receiving the log files associated with applications of Microservices 123-125, 133-135, 153-155, 163-155 from Log Directories 126, 136, 156, 166. In at least one embodiment, a shipper that is implemented at Server 1 120, Server 2 130, Server 3, 150, and Server 4 160 forwards the log files to the OBF 100. The shipper monitors the log files in the Log Directories 126, 136, 156, 166, collects log events, and forwards them to Central OBF device 170. For example, Filebeat® software provides a lightweight shipper whose purpose is to forward and centralize logs from a Kafka® server.

In at least one embodiment, Data Store 171 ingests streaming log files in real-time. Data Store 171 manages the constant influx of log files that are then provided to Log Processor 172. In at least one embodiment, Central OBF 170 implements Data Store 171 as a Kafka® server. In at least one embodiment, Data Store 171 is a distributed system of Kafka® servers communicating with Log Processor 172. For example, Data Store 171 implements Kafka® servers as a cluster of one or more servers that can span multiple datacenters or cloud regions. Kafka® servers receive the log files received at Central OBF 170. Kafka® servers decouple data streams so there is very low latency. Kafka® servers store and process data streams as log files are received.

Log Processor 172 processes the log files automatically streamed steadily from the Log Directories 126, 136, 156, 166 as the log files are received to identify faults of the applications associated with the log files. For example, once a log file is available in Kafka® server, a Spark job parses the log files to obtain meaningful information about the log file. Log Files are parsed according to recognized formats, such as JSON and XML. Log Files in other formats are parsed using additional parsing rules.

A Database 180 stores rules for identifying and generating error messages or alarms identifying the faults of the application associated with the log files. The format of the log files depend on the type used by a particular vendor. For example, a JSON (JavaScript Object Notation) log file provides a structured data format and, in at least one embodiment, incudes key value pairs. Vendors using the JSON log file format share the key name used for fault detection and a value identifying the fault.

Log Processor 172 identifies the log file and the value identifying the fault. Log Processor 172 detects anomalies from analysis of the log files. For example, suspicious events or data associated with error messages are identified. Database 180 stores Rules/Templates 182 that are used to defines rules and log fault patterns, and are applied to the log files to detect faults. In at least one embodiment, Database 180 includes a Logging yaml File 184 that is applied to the log files to identify faults from the log files. Logging yaml File 184 is a regular expression that includes “$.spec.pattern” and “$spec.pattern.type” to define patterns and pattern types for identifying faults from the log files. The Logging yaml File 184 defines log file formats, filters, and processing options. Once the regular expression of the Logging yaml File 184 is applied, a key value is obtained that identifies the log as a fault.

Vendors provide information or identifiers for identifying logs from their applications. Such identifiers are included in the log files for identifying a fault event or alarm. Identifiers include values, such as an alarm or event value to identify the type of fault. The log files are provided by applications in one or more different formats, such as plain-text files, JSON (JavaScript Object Notation) files, XML files, etc. Log Processor 172 accesses Database 180 to obtain a Template 182 to apply to identified faults. Log Processor 172 applies Rules/Template 182 to the identified faults and generates Errors Messages 178.

In at least one embodiment, the log files automatically streamed from the at least one log directory are processed as the log files are received to generate deserialized log files. Deserializing involves the parsing of the log file to obtain meaningful information from the log file. In at least one embodiment, a Spark job is used to deserialize the data. For example, computer data is usually transmitted in a serialized form. For example, deserialized data is organized in data structures such as arrays, records, graphs, classes, or other configurations for efficiency. Serialization converts and changes the data organization into a linear format. XML, YAML, and JSON are commonly used formats for serialized data. Using Java as an example platform for serialization, an object of type Address would logically have separate objects of Street, City, State, And Postal Code. Once serialized, this data is converted into a linear data format (such as the XML text form in the diagram) representing the Address object, e.g., <Address><Street>123 Main Street</Street><City>Smithville</City><State>New York</State><Postal Code>12345</Postal Code></Address>. Deserialization reverses the process and causes the Address objects to be instantiated in memory as separate objects.

In at least one embodiment, the data is enriched and the enriched log data is returned for further processing. Enriching the log file data involves processing the deserialized log files to add information. For example, such additional information includes data for supporting searching of the enriched log files.

Fault Detection 174 is performed to identify faults in the log files. In response to faults not being detected 179, the Log Processor 172 monitors for additional log files that are received by Central OBF 170. In response to faults being identified in the log files 176, Error Messages 178 identifying the faults of the applications associated with the log files are generated. A faults is identified in the log files through a key value in the log file. Error Messages 178 that are generated are based on the fault associated with the key value. Error Messages 178 are converted to a predetermined format and sent to a North Bound Process 190, such as Operations Support System (OSS). Operations Support System (OSS) is used to provide management, inventory, engineering, planning, and repair functions. Upon receipt of logging errors, OSS logs the issue and generates a trouble ticket that is sent to personnel to begin the repair process. Alerts based on the identified faults are used to address the faults.

North Bound Process 190 receives Error Messages 178 via Connection 192. Connection 192 is implemented using at least one of a wireless connection and a wired connection. In at least one embodiment, Connection 192 is implemented as a wireless connection in accordance with any IEEE 802.11 Wi-Fi protocols, Bluetooth protocols, Bluetooth Low Energy (BLE), or other short range protocols that operate in accordance with a wireless technology standard for exchanging data using any licensed or unlicensed band such as the citizens broadband radio service (CBRS) band, 2.4 GHz bands, 5 GHz bands, or 6 GHz bands. Additionally, in at least one embodiment, Connection 192 is implemented using a wireless connection that operates in accordance with, but is not limited to, RF4CE protocol, ZigBee protocol, Z-Wave protocol, or IEEE 802.15.4 protocol. In at least one embodiment, Connection 192 is implemented using a coax (MoCA) network. In at least one embodiment, Connection 192 is a wired Ethernet connection.

North Bound Process 190 identifies incidents and appropriate tickets are created in response to the Error Messages 178 along with the identification of the severity of the faults. The ticket identifies the fault and provides other information and is assigned to a developer or other worker for solving the issue associated with the ticket.

Log file data, such as log files not identified as being associated with a fault 179, is stored in a storage device, such as Database 180. In at least one embodiment, Database 180 includes an Open Distro Elasticsearch Database. Open Distro is an open source cloud-native tool that is able to store the log file data, which is then able to be visualized on Kibana and other dashboard interfaces. Such dashboard interfaces present a visualization of the log file data on a display device for analysis. For example, Elasticsearch provides a distributed, multitenant-capable full-text search engine with an HTTP web interface and schema-free JSON documents. Elasticsearch includes a distributed search and analytics engine configured for log analytics, full-text search, and operational intelligence use cases. In response to faults not being identified in the log files, the OBF 100 continues to process received log files at the Log Processor 172.

OBF 100 reduces major debugging time compared to manually accessing log directories to identify faults. In at least one embodiment, the OBF 100 works with any application running on any cloud native environment. In a cloud native environment, there are usually many clusters, wherein some servers or simple machines are part of the clusters. Rather than having to manually access application log files from a log directory, the OBF automates the collection of log files from one or more log directories s and analysis of the log files is performed in the cloud.

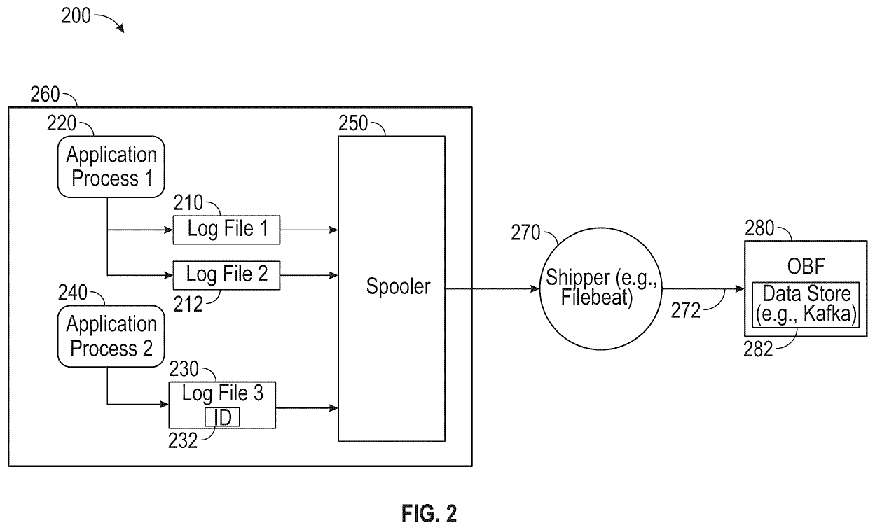

FIG. 2 illustrates a Log Shipper 200 according to at least one embodiment.

In FIG. 2, Log File 1 210, and Log File 2 212 are generated by Application Process 1 220. Log File 3 230 is generated by Application Process 2 240. Log File 1 210, Log File 2 212, and Log File 3 230 are provided to a Spooler 250 in Log Directory 260. A Shipper 270 monitors Log File 1 210, Log File 2 212, and Log File 3 230 in Log Directory 260. In response to Log File 1 210, Log File 2 212, and Log File 3 230 being written to Log Directory 260, Log File 1 210, Log File 2 212, and Log File 3 230 are pushed to the OBF 280 via Connection 272.

Connection 272 is implemented using at least one of a wireless connection and a wired connection. In at least one embodiment, Connection 272 is implemented as a wireless connection in accordance with any IEEE 802.11 Wi-Fi protocols, Bluetooth protocols, Bluetooth Low Energy (BLE), or other short range protocols that operate in accordance with a wireless technology standard for exchanging data using any licensed or unlicensed band such as the citizens broadband radio service (CBRS) band, 2.4 GHz bands, 5 GHz bands, or 6 GHz bands. Additionally, in at least one embodiment, Connection 272 is implemented using a wireless connection that operates in accordance with, but is not limited to, RF4CE protocol, ZigBee protocol, Z-Wave protocol, or IEEE 802.15.4 protocol. In at least one embodiment, Connection 272 is implemented using a coax (MoCA) network. In at least one embodiment, Connection 272 is a wired Ethernet connection.

In at least one embodiment, Shipper 270 is a Filebeat® process that forwards Log File 1 210, Log File 2 212, and Log File 3 230 to the OBF 280. Shipper 270 monitors Log Directory 260, collects log events, and forwards Log File 1 210, Log File 2 212, and Log File 3 230 to OBF 280. Shipper 270 steadily streams Log File 1 210, Log File 2 212, and Log File 3 230 to OBF 280.

OBF 280 implements Data Store 282 for continuously receiving the log files associated with applications from log directories. In at least one embodiment, Data Store 282 ingests streaming log files in real-time. Data Store 282 manages the constant influx of log files that are then provided to a log processor for processing. In at least one embodiment, OBF 280 implements Data Store 282 as a Kafka® server. In at least one embodiment, Data Store 282 is a distributed system of Kafka® servers communicating with the log processor. For example, Data Store 282 implements Kafka® servers as a cluster of one or more servers that can span multiple datacenters or cloud regions.

In FIG. 2, Log File 3 230 includes an Identifier (ID) 232. Identifier 232 are included in the log files for identifying a fault event or alarm. While not shown in FIG. 2, Log File 1 210 and Log File 2 212 also include identifiers.

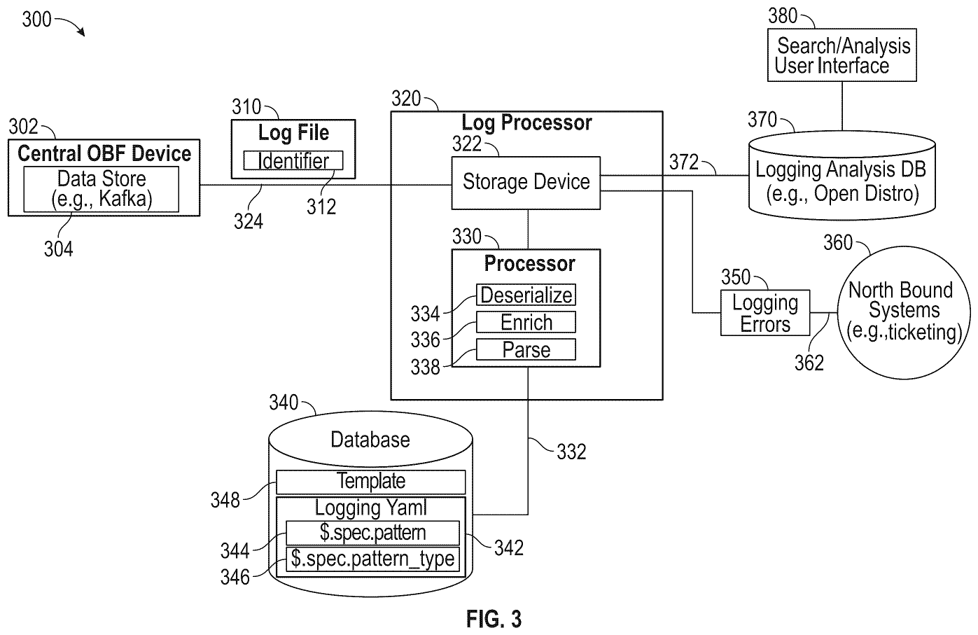

FIG. 3 illustrates a Log Processing System 300 according to at least one embodiment.

In FIG. 3, Central OBF Device 302 provides Log Files 310 to Storage Device 322 of Log Processor 320 via Connection 324. The Log Files 310 are written to Storage Device 322 for processing by Processor 330.

Central OBF Device 302 implements Data Store 304 for continuously receiving the log files associated with applications from log directories. In at least one embodiment, Data Store 304 ingests streaming log files in real-time. Data Store 304 manages the constant influx of log files that are then provided to a log processor for processing. In at least one embodiment, Central OBF 302 implements Data Store 304 as a Kafka® server. In at least one embodiment, Data Store 304 is a distributed system of Kafka® servers communicating with the log processor. For example, Data Store 304 implements Kafka® servers as a cluster of one or more servers that can span multiple datacenters or cloud regions.

Processor 330 accesses Database 340 via Connection 332 to obtain Logging Yaml File 342 for processing the Log Files 310. Logging Yaml File 342 is a logging configuration file. Logging Yaml File 342 includes $.spec.pattern 344 and $.spec.pattern_type 346 that are used to identify a pattern and pattern type of faults, respectively, in Log Files 310.

In at least one embodiment, Log Files 310 are automatically streamed from at least one log directory and are processed by Processor 330 at Log Processor 320 as Log Files 310 are received. Processor 330 performs one or more processes to analyze the Log Files 310. For example, in at least one embodiment, Processor 330 performs Deserializing 334 on Log Files 310. Deserializing 334 involves the parsing of the Log Files 310 to obtain meaningful information from the Log Files 310. In at least one embodiment, a Spark job is used to deserialize the data.

In at least one embodiment, Processor 330 performs Enriching 336 on the data obtain from the Log Files 310. Enriching 336 the data of Log Files 310 involves processing the Log Files 310 to add information. For example, such additional information includes data for supporting searching of the enriched Log Files 310. In at least one embodiment, Processor 330 performs Parsing 338 of the Log Files 310 to identify faults of applications associated with the Log Files 310. Log Files are parsed according to recognized formats, such as JSON and XML. Log Files in other formats are parsed using additional parsing rules. In at least one embodiment, Identifiers 312 are included in Log Files 310 for identifying a fault/event or alarm. Identifiers 312 include values, such as an alarm or event value to identify the type of fault. The Log Files 310 are provided by applications in one or more different formats, such as plain-text files, JSON (JavaScript Object Notation) files, XML files, etc.

Processor 330 accesses Database 340 to obtain a Template 348 to apply to identified faults. Processor 330 applies Template 348 to the identified faults and generates Logging Errors 350. Processor 330 causes Logging Errors 350 to be sent to North Bound Systems 360 via Connection 362. For example, in at least one embodiment, in response to receiving Logging Errors 350 at North Bound Systems 360, North Bound Systems 360 identify incidents and appropriate tickets are created in response to the incidents along with the identification of the fault and its severity. The ticket identifies the fault and provides other information and is assigned to a developer or other worker for addressing the issue associated with the ticket.

In at least one embodiment, Storage Device 322 sends log file data to Logging Analysis Database (DB) 370 via Connection 372. In at least one embodiment, log file data, such as log files not identified as being associated with a fault, is stored in Logging Analysis Database (DB) 370. In at least one embodiment, Logging Analysis Database (DB) 370 stores log data associated with log files identified as being associated with a fault. In at least one embodiment, Logging Analysis Database (DB) 370 includes an Open Distro Elasticsearch Database. Open Distro is an open source cloud-native tool that is able to store the log file data, which is then able to be visualized on Kibana and other dashboard interfaces. Such dashboard interfaces present a visualization of the log file data on a display device for analysis. For example, Elasticsearch provides a distributed, multitenant-capable full-text search engine with an HTTP web interface and schema-free JSON documents. Elasticsearch includes a distributed search and analytics engine configured for log analytics, full-text search, and operational intelligence use cases. In response to faults not being identified in the log files, received log files continue to be processed at the Log Processor 320.

Connections 324, 332, 362, 372 are implemented using at least one of a wireless connection and a wired connection. In at least one embodiment, Connections 324, 332, 362, 372 are implemented as a wireless connection in accordance with any IEEE 802.11 Wi-Fi protocols, Bluetooth protocols, Bluetooth Low Energy (BLE), or other short range protocols that operate in accordance with a wireless technology standard for exchanging data using any licensed or unlicensed band such as the citizens broadband radio service (CBRS) band, 2.4 GHz bands, 5 GHz bands, or 6 GHz bands. Additionally, in at least one embodiment, Connections 324, 332, 362, 372 are implemented using a wireless connection that operates in accordance with, but is not limited to, RF4CE protocol, ZigBee protocol, Z-Wave protocol, or IEEE 802.15.4 protocol. In at least one embodiment, Connections 324, 332, 362, 372 are implemented using a coax (MoCA) network. In at least one embodiment, Connections 324, 332, 362, 372 are a wired Ethernet connection.

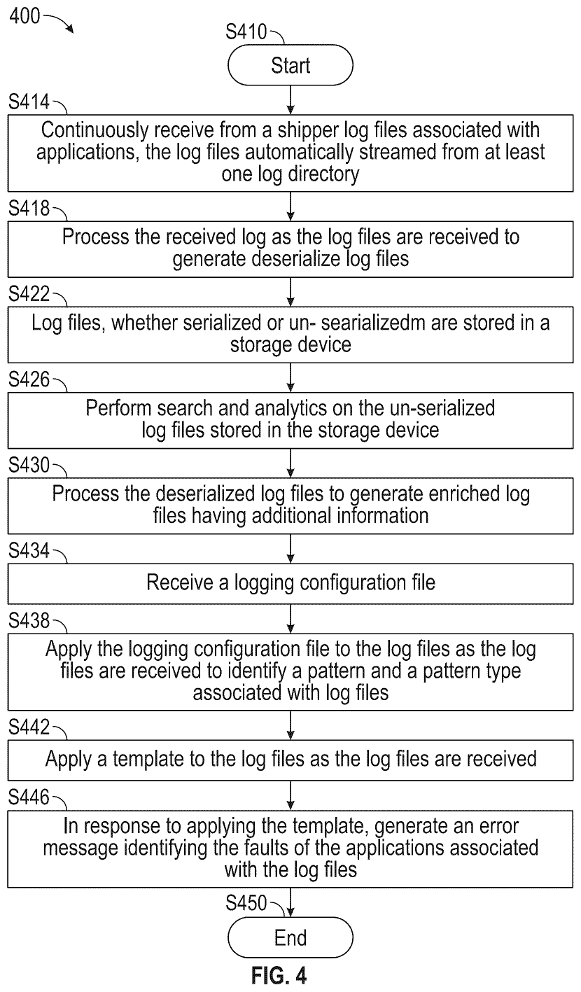

FIG. 4 is a flowchart of a method 400 for providing cloud application fault detection according to at least one embodiment.

In FIG. 4, method 400 starts (S410), and log files associated with applications, log files associated with applications automatically streamed from at least one log directory are continuously received from a shipper (S414). Referring to FIG. 2, a Shipper 270 monitors Log File 1 210, Log File 2 212, and Log File 3 230 in Log Directory 260. In response to Log File 1 210, Log File 2 212, and Log File 3 230 being written to Log Directory 260, Log File 1 210, Log File 2 212, and Log File 3 230 are pushed to the OBF 280 via Connection 272. In at least one embodiment, Shipper 270 is a Filebeat® process that forwards Log File 1 210, Log File 2 212, and Log File 3 230 to the OBF 280. Shipper 270 monitors Log Directory 260, collects log events, and forwards Log File 1 210, Log File 2 212, and Log File 3 230 to OBF 280 via Connection 272. Shipper 270 steadily streams Log File 1 210, Log File 2 212, and Log File 3 230 to OBF 280.

The received log are processed as the log files are received to generate deserialized log files (S418). Referring to FIG. 3, in at least one embodiment, Processor 330 performs one or more processes to analyze the Log Files 310. For example, in at least one embodiment, Processor 330 performs Deserializing 332 on Log Files 310. Deserializing 332 involves the parsing of the Log Files 310 to obtain meaningful information from the Log Files 310. In at least one embodiment, a Spark job is used to deserialize the data.

Log files, whether serialized or un-serialized, are stored in a storage device (S422). Referring to FIG. 1, Log file data, such as log files not identified as being associated with a fault 179, is stored in a storage device, such as Database 180. Referring to FIG. 3, in at least one embodiment, log file data, such as log files not identified as being associated with a fault, is stored in Logging Analysis Database (DB) 370. In at least one embodiment, Logging Analysis Database (DB) 370 stores log data associated with log files identified as being associated with a fault.

Search and analytics are performed on the log files stored in the storage device (S426). Referring to FIG. 3, in at least one embodiment, Logging Analysis Database (DB) 370 includes an Open Distro Elasticsearch Database. Open Distro is an open source cloud-native tool that is able to store the log file data, which is then able to be visualized on Kibana and other dashboard interfaces. Such dashboard interfaces present a visualization of the log file data on a display device for analysis. For example, Elasticsearch provides a distributed, multitenant-capable full-text search engine with an HTTP web interface and schema-free JSON documents. Elasticsearch includes a distributed search and analytics engine configured for log analytics, full-text search, and operational intelligence use cases. In response to faults not being identified in the log files, received log files continue to be processed at the Log Processor 320.

The deserialized log files are processed to generate enriched log files having additional information (S430). Referring to FIG. 3, in at least one embodiment, Processor 330 performs Enriching 336 on the data obtain from the Log Files 310. Enriching 336 the data of Log Files 310 involves processing the Log Files 310 to add information. For example, such additional information includes data for supporting searching of the enriched Log Files 310.

A logging configuration file is received (S434). Referring to FIG. 1, Database 180 includes a Logging yaml File 184 that is applied to the log files to identify faults from the log files.

The logging configuration file is applied to the log files as the log files are received to identify a pattern and a pattern type associated with log files (S438). Referring to FIG. 3,

Logging yaml File 184 is a regular expression that includes “$.spec.pattern” and “$spec.pattern.type” to define patterns and pattern types for identifying faults from the log files. The Logging yaml File 184 defines log file formats, filters, and processing options. Once the regular expression of the Logging yaml File 184 is applied, a key value is obtained that identifies the log as a fault.

A template is applied to the log files as the log files are received (S442). Referring to FIG. 3, Log Processor 172 accesses Database 180 to obtain a Template 182 to apply to identified faults. Processor 330 applies Template 348 to the identified faults and generates Logging Errors 350.

In response to applying the template, an error message identifying the faults of the applications associated with the log files is generated (S446). Referring to FIG. 3, Processor 330 applies Template 348 to the identified faults and generates Logging Errors 350. Processor 330 causes Logging Errors 350 to be sent to North Bound Systems 360 via Connection 362. For example, in at least one embodiment, in response to receiving Logging Errors 350 at North Bound Systems 360, North Bound Systems 360 identify incidents and appropriate tickets are created in response to the incidents along with the identification of the fault and its severity. The ticket identifies the fault and provides other information and is assigned to a developer or other worker for addressing the issue associated with the ticket. The method then ends (S450).

At least one embodiment of a method for providing cloud application fault detection includes receiving, at a processor from at least one log directory associated with at least one server, log files associated with applications running on the at least one server, the log files automatically streamed from the at least one directory, storing in memory by the processor, the log files automatically streamed from the at least one log directory as the log files are received, obtaining, by the processor from a database, a template for identifying faults of the applications associated with the log files automatically streamed from the at least one log directory, applying, by the processor, the template to the log files stored in the memory to identify the faults of the applications associated with the log files, obtaining, by the processor from the database, a configuration file from the database for generating an error message identifying the faults of the applications associated with the log files automatically streamed from the at least one log directory, applying, by the processor, the configuration file to the log files stored in the memory to generate the error message identifying the faults of the applications associated with the log files, and transmitting, by the processor over a network, the error messages to an operations support system for addressing the faults of the applications associated with the log files.

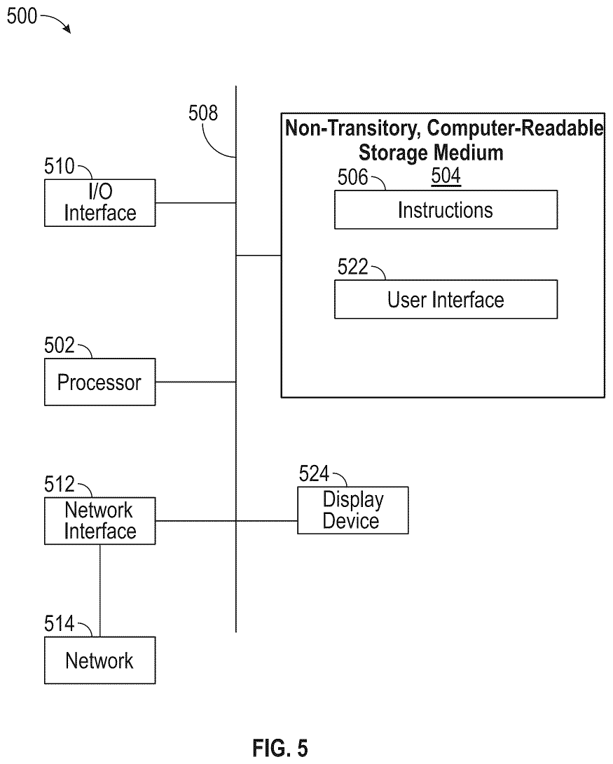

FIG. 5 is a high-level functional block diagram of a processor-based system 500 according to at least one embodiment.

In at least one embodiment, processing circuitry 500 provides end-to-end application onboarding. Processing circuitry 500 implements automatic detection of faults in log files steadily received from one or more log directories in a cloud-based system using processor 502. Processing circuitry 500 also includes a non-transitory, computer-readable storage medium 504 that is used to implement automatic detection of faults in log files steadily received from one or more log directories in a cloud-based system. Storage medium 504, amongst other things, is encoded with, i.e., stores, instructions 506, i.e., computer program code that are executed by processor 502 causes processor 502 to perform operations for automatic detection of faults in log files steadily received from one or more log directories in a cloud-based system. Execution of instructions 506 by processor 502 represents (at least in part) a cloud application fault detection system which implements at least a portion of the methods described herein in accordance with one or more embodiments (hereinafter, the noted processes and/or methods).

Processor 502 is electrically coupled to computer-readable storage medium 504 via a bus 508. Processor 502 is electrically coupled to an Input/output (I/O) interface 510 by bus 508. A network interface 512 is also electrically connected to processor 502 via bus 508. Network interface 512 is connected to a network 514, so that processor 502 and computer-readable storage medium 504 connect to external elements via network 514. Processor 502 is configured to execute instructions 506 encoded in computer-readable storage medium 504 to cause processing circuitry 500 to be usable for performing at least a portion of the processes and/or methods. In one or more embodiments, processor 502 is a Central Processing Unit (CPU), a multi-processor, a distributed processing system, an Application Specific Integrated Circuit (ASIC), and/or a suitable processing unit.

Processing circuitry 500 includes I/O interface 510. I/O interface 510 is coupled to external circuitry. In one or more embodiments, I/O interface 510 includes a keyboard, keypad, mouse, trackball, trackpad, touchscreen, and/or cursor direction keys for communicating information and commands to processor 502.

Processing circuitry 500 also includes network interface 512 coupled to processor 502. Network interface 512 allows processing circuitry 500 to communicate with network 514, to which one or more other computer systems are connected. Network interface 512 includes wireless network interfaces such as Bluetooth, Wi-Fi, Worldwide Interoperability for Microwave Access (WiMAX), General Packet Radio Service (GPRS), or Wideband Code Division Multiple Access (WCDMA); or wired network interfaces such as Ethernet, Universal Serial Bus (USB), or Institute of Electrical and Electronics Engineers (IEEE) 564.

Processing circuitry 500 is configured to receive information through I/O interface 510. The information received through I/O interface 510 includes one or more of instructions, data, design rules, libraries of cells, and/or other parameters for processing by processor 502. The information is transferred to processor 502 via bus 508. Processing circuitry 500 is configured to receive information related to a User Interface (UI) 522 through I/O interface 510. The information is stored in computer-readable medium 504 as UI 522. A visualization of log file data is presented on Display Device 524 for analysis.

In one or more embodiments, one or more non-transitory computer-readable storage media 504 having stored thereon instructions (in compressed or uncompressed form) that may be used to program a computer, processor, or other electronic device) to perform processes or methods described herein. The one or more non-transitory computer-readable storage media 504 include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. In one or more embodiments using optical disks, the one or more non-transitory computer-readable storage media 504 includes a Compact Disk-Read Only Memory (CD-ROM), a Compact Disk-Read/Write (CD-R/W), and/or a Digital Video Disc (DVD).

In one or more embodiments, storage medium 504 stores computer program code 506 configured to cause processing circuitry 500 to perform at least a portion of the processes and/or methods for end-to-end application onboarding. In one or more embodiments, storage medium 504 also stores information, such as algorithm which facilitates performing at least a portion of the processes and/or methods for automatic detection of faults in log files steadily received from one or more log directories in a cloud-based system. Accordingly, in at least one embodiment, the processor circuitry 500 performs a method for providing cloud application fault detection that includes at least receiving, at a processor from at least one log directory associated with at least one server, log files associated with applications running on the at least one server, the log files automatically streamed from the at least one directory, storing in memory by the processor, the log files automatically streamed from the at least one log directory as the log files are received, obtaining, by the processor from a database, a template for identifying faults of the applications associated with the log files automatically streamed from the at least one log directory, applying, by the processor, the template to the log files stored in the memory to identify the faults of the applications associated with the log files, obtaining, by the processor from the database, a configuration file from the database for generating an error message identifying the faults of the applications associated with the log files automatically streamed from the at least one log directory, applying, by the processor, the configuration file to the log files stored in the memory to generate the error message identifying the faults of the applications associated with the log files, and transmitting, by the processor over a network, the error messages to an operations support system for addressing the faults of the applications associated with the log files.

Advantages include a system that provides quick and easy identification of faults from logs as log files are received. The cloud application fault detection enables events from large applications to be processes. Further, the cloud application fault detection is able to handle log files received from multiple, geographically distributed servers.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the embodiments have been described in language specific to structural features or methodological acts, the subject matter defined in the appended claims is not necessarily limited to the specific features or acts described. Rather, the specific features and acts are disclosed as exemplary forms of implementing the claims.

What is claimed is:

1. A method for providing cloud application fault detection, the method comprises:
receiving, at a processor from at least one log directory associated with at least one server, log files associated with applications running on the at least one server, the log files automatically streamed from the at least one directory;
storing, in memory by the processor, the log files automatically streamed from the at least one log directory as the log files are received;
obtaining, by the processor from a database, a template for identifying faults of the applications associated with the log files automatically streamed from the at least one log directory;
applying, by the processor, the template to the log files stored in the memory to identify the faults of the applications associated with the log files;
obtaining, by the processor from the database, a configuration file from the database for generating an error message identifying the faults of the applications associated with the log files automatically streamed from the at least one log directory;
applying, by the processor, the configuration file to the log files stored in the memory to generate the error message identifying the faults of the applications associated with the log files; and
transmitting, by the processor over a network, the error messages to an operations support system for addressing the faults of the applications associated with the log files.

2. The method of claim 1, wherein the log files automatically streamed from the at least one log directory are continuously streamed from the at least one log directory and obtained by the processor.

3. The method of claim 1, wherein the applying, by the processor, the template to the log files to identify the faults of the applications associated with the log files further comprises:
determining, by the processor based on the template, a value in the log files identifying the fault.

4. The method of claim 1, wherein the receiving, at the processor, the log files further comprises continuously receiving, at the processor, the log files from a log file shipper.

5. The method of claim 1 further comprising:
processing, by the processor, the log files automatically streamed from the at least one log directory as the log files are received, by the processor, to generate deserialized log files; and
processing, by the processor, the deserialized log files to generate enriched log files having additional information.

6. The method of claim 1, wherein the applying, by the processor, the configuration file to the log files further comprises:
receiving, at the processor, a logging yaml file including patterns and pattern types associated with faults; and
applying, by the processor, the logging yaml file to the log files including at least one of the patterns and at least one of the pattern types to identify a particular error associated with at least one of the faults.

7. The method of claim 1, further comprising:
processing, by the processor, the log files automatically streamed from the at least one log directory as the log files are received to generate un-serialized log files;
storing, by the processor, the un-serialized log files in a storage device; and
performing, by the processor, log analytics on the un-serialized log files to identify information about the log file.

8. The method of claim 1, further comprising:
storing, by the processor, log data associated with the log files in a storage device; and
presenting, by the processor on a display device, a visualization of the log data associated with the log files.

9. A system for providing cloud application fault detection, the system comprising:
a memory storing computer-readable instructions; and
a processor connected to the memory, wherein the processor is configured to execute the computer-readable instructions to:
receive, from at least one log directory associated with at least one server, log files associated with applications running on the at least one server, the log files automatically streamed from the at least one directory;
store in the memory the log files automatically streamed from the at least one log directory as the log files are received;
obtain, from a database, a template for identifying faults of the applications associated with the log files automatically streamed from the at least one log directory;
apply the template to the log files stored in the memory to identify the faults of the applications associated with the log files;
obtain, from the database, a configuration file from the database for generating an error message identifying the faults of the applications associated with the log files automatically streamed from the at least one log directory;
apply the configuration file to the log files stored in the memory to generate the error message identifying the faults of the applications associated with the log files; and
transmit, over a network, the error messages to an operations support system for addressing the faults of the applications associated with the log files.

10. The system of claim 9, wherein the processor is further configured to receive continuously streamed log files from the at least one log directory and to determine, based on the template, a value in the log files identifying the fault.

11. The system of claim 9, wherein the processor is further configured to continuously receive the log files from a log file shipper.

12. The system of claim 9, wherein the processor is further configured to:
process the log files automatically streamed from the at least one log directory as the log files are received to generate deserialized log files; and
process the deserialized log files to generate enriched log files having additional information.

13. The system of claim 9, wherein the processor is further configured to apply the configuration file to the log files by receiving a logging yaml file including patterns and pattern types associated with faults and applying the logging yaml file to the log files including at least one of the patterns and at least one of the pattern types to identify a particular error associated with at least one of the faults.

14. The system of claim 9, wherein the processor is further configured to:
store log data associated with the log files in a storage device; and
present on a display device a visualization of the log data associated with the log files.

15. A non-transitory computer-readable media having computer-readable instructions stored thereon, which when executed by a processor causes the processor to perform operations comprising:
receiving, from at least one log directory associated with at least one server, log files associated with applications running on the at least one server, the log files automatically streamed from the at least one directory;
storing in memory the log files automatically streamed from the at least one log directory as the log files are received;
obtaining, from a database, a template for identifying faults of the applications associated with the log files automatically streamed from the at least one log directory;
applying the template to the log files stored in the memory to identify the faults of the applications associated with the log files;
obtaining, from the database, a configuration file from the database for generating an error message identifying the faults of the applications associated with the log files automatically streamed from the at least one log directory;
applying the configuration file to the log files stored in the memory to generate the error message identifying the faults of the applications associated with the log files; and transmitting, over a network, the error messages to an operations support system for addressing the faults of the applications associated with the log files.

16. The non-transitory computer-readable media of claim 15, wherein the log files automatically streamed from the at least one log directory are continuously streamed from the at least one log directory.

17. The non-transitory computer-readable media of claim 15, wherein the applying the template to the log files to identify the faults of the applications associated with the log files further comprises:
determining, based on the template, a value in the log files identifying the fault.

18. The non-transitory computer-readable media of claim 15, wherein the receiving the log files further comprises continuously receiving the log files from a log file shipper.

19. The non-transitory computer-readable media of claim 15, wherein the applying the configuration file to the log files further comprises:
receiving a logging yaml file including patterns and pattern types associated with faults; and
applying the logging yaml file to the log files including at least one of the patterns and at least one of the pattern types to identify a particular error associated with at least one of the faults.

20. The non-transitory computer-readable media of claim 15, further comprising:
storing log data associated with the log files in a storage device; and
presenting on a display device a visualization of the log data associated with the log files.
